(19) United States
(12) Patent Application Publication
(10) Pub. No.: US 2026/0247423 A1
(43) Pub. Date: Aug. 20, 2026

(54) ARCHITECTURE FOR HANDLING MULTIPLE NETWORKS IN A RADIO ACCESS NODE ARRANGEMENT

(71) Applicant: Sony Group Corporation, Tokyo (JP)

(72) Inventor: Torgny PALENIUS, Barsebäck (SE)

(21) Appl. No.: 19/161,290

(22) PCT Filed: Mar. 8, 2024
(86) PCT No.: PCT/EP2024/056264

§ 371 Date: Sep. 1, 2025

(30) Foreign Application Priority Data
Mar. 13, 2023 (SE) 2350275-0

(51) Int. Cl. H04W 72/543; H04W 74/00; H04W 74/0833; H04W 88/08

(52) U.S. Cl. CPC H04W 72/543; H04W 74/006; H04W 74/0833; H04W 88/085

(57) ABSTRACT

An access node arrangement with split layer functionality for operation in a radio access network, said access node arrangement comprising: at least two higher-layer sub-nodes (300, 301), wherein each higher-layer sub-node is configured to implement higher layers (313) of a radio protocol stack for individual core network connectivity (316D); a lower-layer sub-node (200), shared by the higher-layer sub-nodes (300, 301), comprising a radio unit (215) and being configured to implement lower layers (213) supporting the higher layers of the at least two higher-layer sub-nodes (300, 301) and to communicate lower layer data using the radio unit (215); and a scheduler (214); wherein one of said higher-layer sub-nodes is a master sub-node configured to control the scheduler for managing allocation of resources for data communication for any of said higher-layer sub-nodes connected to the lower-layer sub-node.

### TECHNICAL FIELD

This disclosure relates to various aspects of a radio access network of a wireless communication network. Specifically, various architectures and functions of an access node arrangement of a radio access network are provided, comprising different entities or sub-nodes providing split functionality for the access node arrangement.

### BACKGROUND

In radio communication systems, such as various generations provided through the 3rd Generation Partnership Project (3GPP), several releases of specifications have been provided for setting up common rules for establishing and operating both a wireless radio interface between a wireless terminal and a base station, and various levels of operation of the wireless network. Broadly speaking, the wireless network may comprise a Core Network (CN), connected to further networks, such as the Internet. In order to provide wireless device access to the wireless network, a Radio Access Network (RAN) is connected to the CN, inter alia for transferring control signaling and data signaling between wireless terminals and the CN.

In 3GPP documentation, a terminal is commonly referred to as User Equipment (UE), a term that will be used consistently herein for the sake of simplicity. The RAN comprises a multitude of access nodes, operative to provide radio access to UEs. Each access node, also referred as RAN node or base station, may provide connectivity over an air interface within a so-called cell. Various 3GPP releases relate to specifications for radio communication referred to as the 5G type radio communication system (5GS), including the New Radio (NR) technology for RAN, wherein the term gNB is used to identify an access node. The term gNB will also at least occasionally be used herein for the purpose of indicating an access node. In 5G, the core network is further referred to as 5GC.

3GPP specifications for RAN provide for use of split of functionality of the access node (gNB) between a Centralized Unit (CU) and one a Distributed Unit (DU), which can be divided into two physical entities. The DU is placed close to the antenna and the CU is typically placed in a data server. CU provides support for the higher layers of the 5G NR protocol stack, such as SDAP (Service Data Adaption Protocol), PDCP (Packet Data Convergence Protocol) and RRC (Radio Resource Control). DU provides support for the lower layers of the protocol stack such as RLC (Radio link control), MAC (Medium Access Control) and PHY (Physical layer). Practically speaking, there may be a single CU for each gNB, but one CU may control multiple DUs, for example more than 100 DUs can be connected to one CU. The interface between CU and DU is named F1 and as per 3GPP, it should be an open interface, so you connect one CU from one vendor to a DU from another vendor. In such a divided architecture, the CU may be placed in a data center, just like associated CN nodes. Therefore, it is expected that the RAN CU will in the future be more integrated with the CN, whereas the DU is the HW at the site close to the antennas.

The concept of shared RAN has been proposed, where the RAN may be connected to several CNs belonging to different operators. Thereby, the HW in the RAN nodes can be shared by several operators and the frequency spectrum can be shared, even for e.g., private networks or small local operators who do not have its own spectrum. In 3GPP the RAN can be connected to more than one operator where the operators have one CN each, so called MORAN (Multi Operator RAN). There is one interface from each CN for both user plane and control plane. The data is added to a common user plane protocol stack in RAN where the data is added to the 5QI flows based on the respective QoS (Quality of Service).

A foreseeable scenario is that the number of micro-operators will increase in the future, e.g., with deployment of 6G (either as public or non-public networks) in a local area or distributed on many places. The micro-operator may have its own CN but not any licensed spectrum or any access nodes. One solution is to use spectrum shared among many operators or that it can use parts of a larger operator's spectrum and access nodes. This brings about challenges with regard to handling of data traffic associated with different CNs.

### SUMMARY

A general object is to provide solutions to the challenge of configuring a RAN to handle traffic associated with different CNs, which may belong to different network operators. The solutions as proposed herein are defined by the terms of the independent claims, whereas various embodiments are outlined in the dependent claims.

According to one aspect, an access node arrangement with split layer functionality is provided, for operation in a radio access network, said access node arrangement comprising:
at least two higher-layer sub-nodes, wherein each higher-layer sub-node is configured to implement higher layers of a radio protocol stack for individual core network connectivity;
a lower-layer sub-node, shared by the higher-layer sub-nodes, comprising a radio unit and being configured to implement lower layers supporting the higher layers of the at least two higher-layer sub-nodes and to communicate lower layer data using the radio unit; and
a scheduler;
wherein one of said higher-layer sub-nodes is a master sub-node configured to control the scheduler for managing allocation of resources for data communication for any of said higher-layer sub-nodes connected to the lower-layer sub-node.

According to another aspect, a higher-layer sub-node is provided, configured as a master sub-node in an access node arrangement having split-layer functionality for operation in a radio access network. The higher-layer sub-node comprising comprises:
an interface configured to provide connectivity with one core network;
logic circuitry configured to implement higher layers of a radio protocol stack; and
a communication interface configured for connection to a lower-layer sub-node, configured to implement lower layers the higher layers of each of a plurality of higher-layer sub-nodes in parallel, to obtain full support of the radio protocol;
wherein the logic circuitry is configured to a control a scheduler to manage resource allocation for any higher-layer sub-node connected to the lower-layer sub-node.

According to yet another aspect, a higher-layer sub-node is provided for use in an access node arrangement having split-layer functionality for operation in a radio access network. The higher-layer sub-node comprises:
an interface configured to provide connectivity with one core network;
logic circuitry configured to implement higher layers of a radio protocol stack; and
a communication interface configured for connection to a lower-layer sub-node configured to implement lower layers supporting the higher layers of a plurality of higher-layer sub-nodes in parallel, wherein the higher-layer sub-node obtains full support of the radio protocol stack using said communication interface; and
an interface to a scheduler under control of a further higher-layer sub-node operating as master sub-node for resource allocation by the scheduler for said higher-layer sub-node, wherein the higher-layer sub-node is configured as a slave sub-node to the master sub-node.

The proposed solution, and its various aspects, stems from the understanding that the functionality and support of the CU and big parts of the DU can today be implemented in data centers, in many cases the same data center as the corresponding Core Network is running. With the architecture today using, e.g., MORAN (Multi Operator RAN), everything in the RAN (antenna, tower, site, power) except the radio carriers is shared between two or more operators. In such a solution, all data is sent to the same common data center where it is processed and then it is sent to/from the data centers where the Core Network of the different operators are running for further distribution. Furthermore, the data in DL is, after it is sent to the RAN, handled in a common way using the different available 5QI flows. It is not possible to directly control the load of each operator on the air interface.

The proposed solution, on the other hand, provides an efficient architecture and operation of a shared access node, where split functionality is defined with a lower-layer part, configured to operate in combination with a plurality of higher-layer parts of different networks and operators. The lower-layer entity is controllable to manage resource allocation and scheduling based on the network to which the data is associated. The proposed solution thus provides a technical solution which facilitates a convenient balance between micro-operator's need for spectrum use, and the need for network-owning operators to control traffic and usage. By configuring the access node arrangement such that one higher-layer sub-node acts as a master for any connected higher-layer sub-nodes, and by extension for a plurality of core networks, resource allocation and scheduling may be conveniently controlled. Moreover, radio resource control may be operated under control of the master sub-node, even though the access node arrangement is used by a plurality of core networks, such as for signaling and for handling random access.

### BRIEF DESCRIPTION OF THE DRAWINGS

Various embodiments will be described with reference to the drawings.

FIG. 1 schematically illustrates a wireless network comprising a radio access network which includes at least two base stations, wherein each base station comprises a central unit and at least one distributed unit.

FIG. 2A schematically illustrates split functionality and protocol layer handling in a RAN access node arrangement, according to various examples of the proposed solution, where a common lower-layer entity is provided.

FIG. 2B schematically the architecture of FIG. 2A, further identifying that the distributed unit is split into a network-specific part and a shared common lower-layer part.

FIG. 2C schematically an example of an architecture similar of FIG. 2A, but with a different scheduler arrangement.

FIG. 3 schematically illustrates functional elements included in a lower-layer sub-node, usable by plural connected network-specific higher-layer sub-nodes, according to various embodiments of the proposed solution.

FIG. 4 schematically illustrates functional elements included in a higher-layer sub-node, connectable to the lower-layer sub-nodes to obtain base station functionality for one network, according to various embodiments of the proposed solution.

FIG. 5 illustrates a signaling diagram showing various signals and configuration steps that may be included in various embodiments of the proposed solution.

### DETAILED DESCRIPTION

The invention will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, when an element is referred to as being “connected” to another element, it can be directly connected to the other element or intervening elements may be present. In contrast, when an element is referred to as being “directly connected” to another element, there are no intervening elements present. Like numbers refer to like elements throughout. It will furthermore be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

Well-known functions or constructions may not be described in detail for brevity and/or clarity. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

Embodiments of the invention are described herein with reference to schematic illustrations of idealized embodiments of the invention. As such, variations from the shapes and relative sizes of the illustrations as a result, for example, of manufacturing techniques and/or tolerances, are to be expected. Thus, embodiments of the invention should not be construed as limited to the particular shapes and relative sizes of regions illustrated herein but are to include deviations in shapes and/or relative sizes that result, for example, from different operational constraints and/or from manufacturing constraints. Thus, the elements illustrated in the figures are schematic in nature and their shapes are not intended to illustrate the actual shape of a region of a device and are not intended to limit the scope of the invention. It may be noted that where this disclosure mentions transmission or reception of information, this information may be conveyed in one or more messages.

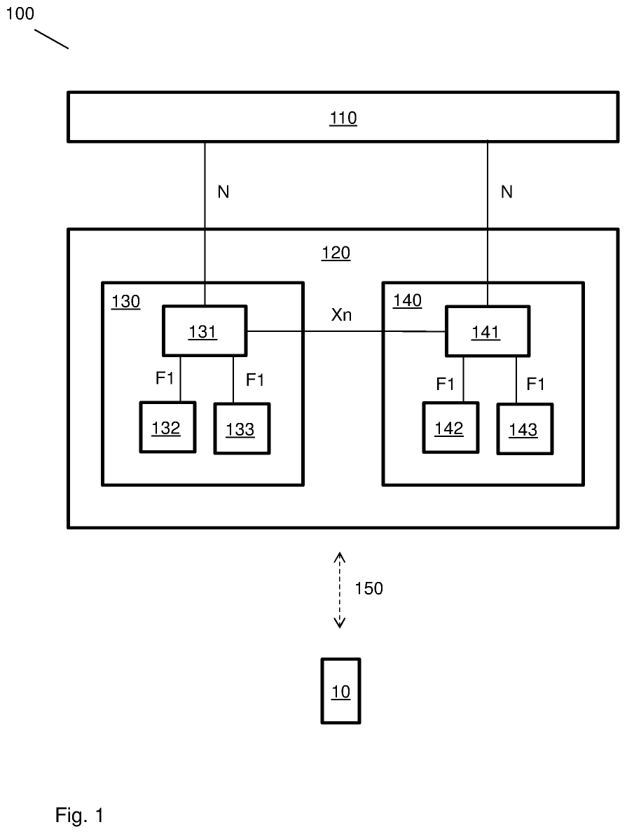

FIG. 1 illustrates a wireless network 100 in a deployment usable for understanding the proposed solution. The wireless network 100 may be a radio communication network operating under general and specific regulations and limits published by the 3GPP. The wireless network 100 may include a core network 110, which is connected to other networks, such as the Internet. The wireless network 100 further includes an access network 120, which comprises a plurality of base stations or access nodes, of which a first base station 130 and a second base station 140 are shown.

Moreover, a UE 10 is illustrated, which may access the wireless network through any of the base stations included in the RAN 120. The UE 10 may be any device operable to wirelessly communicate with the network 100 through the base station 130, 140, such as a mobile telephone, computer, tablet, a M2M device, an IoT device or other.

In the RAN 120 of FIG. 1, at least the two base stations 130 and 140 are configured with an architecture wherein the base station functionality is divided into two different types of entities. In legacy 3GPP terminology, each access node 130, 140 may comprise a first entity which is a central unit (CU) 131, 141 and a second entity which is one or several distributed unit(s) (DU) 132, 133 and 142, 143, respectively. Such an architecture type is inter alia described in 3GPP technical specification TS 38.401 version 15.6.0 Release 15 section 6. The CU is handling the SDAP/PDCP/RRC, and DU is handling RLC/MAC/PHY. The CU and DU are connected via a logical interface F1, which can either transport control signaling V1-C or data packet V1-U. Each DU serves one cell, and has an associated cell ID. The actual point of transmission and reception of the respective DU 132, 133, 142, 143 may be referred to as a Transmission and Reception Point (TRP), which may be seen as a network node which includes or is co-located with an antenna system of the respective DU.

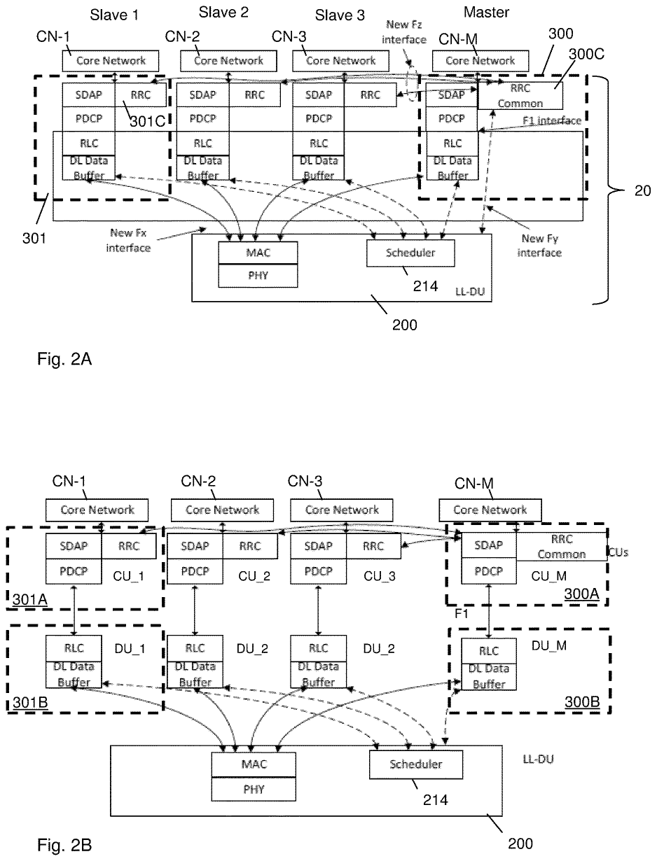

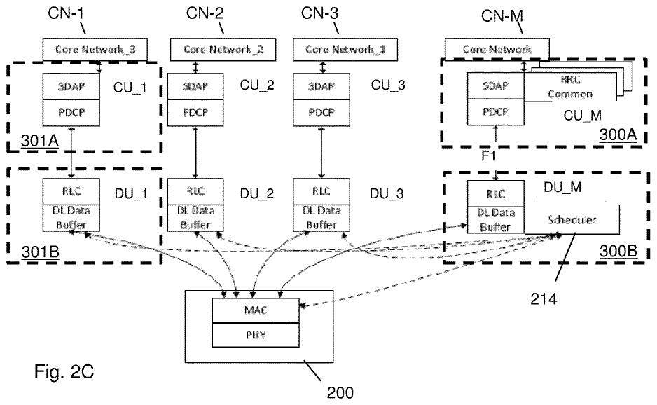

Various aspects of the proposed solutions will be described below with reference to the drawings, specifically FIGS. 2A, 2B, 2C, 3, and 4. The proposed solution is based on the idea that different operators with different Core Networks shall be able to share at least parts of the access node HW located near the antennas as well as associated SW for operating the HW. Herein, this HW and its logic circuitry is referred to as a lower-layer sub-node, or LL-DU, and incorporates logic circuitry which implements lower layers of the radio protocol stack, e.g., the 5G NR protocol stack. The LL-DU further comprises interfaces to complementary parts of the protocol stack, implemented in different higher-layer sub-nodes belonging to the different operators. In this context, a sub-node is a functional entity that is a sub-part of an access node, e.g., a gNB, which implements parts of the complete/whole radio protocol stack implemented by the access node. The proposed solution identifies, for an access node of a network belonging to one operator, one functional entity configured to implement higher layers, and one functional entity configured to implement lower layers. A split is configured between co-operating sub-nodes, where the functional entity handling the lower layers is configured in the lower-layer sub-node (LL-DU) and the functional entity handling the higher layers is configured in the higher-layer sub-node.

In one example the lower layers comprise physical layer functionality such as multiplexing, encoding and modulating DL data and correspondingly demodulating, decoding and demultiplexing UL data as described in 3GPP technical specification 38.212. It also receives L1 control information and measurement results from the UE which is used in mainly a scheduler for UL and DL data resource allocation. The lower layers may also comprise MAC layer which receives the data from PHY where the destination and quality of each data can be handled, e.g., the different QoS flows are handled there. In the solution proposed herein, the MAC layer is also configured to send the data to the correct sub-node forming a higher layer entity.

The functional entity handling higher layers comprises a data buffer for DL data and operates link layer protocol with retransmissions etc. connected to each UE link. This functional entity is further configured to implement PDCP and SDAP layers and to pass data to these higher layers which e.g., handle different QoS flows and the interface to the Core Network for user plane and to the RRC layer for the control plane. The RRC layer of this functional entity controls all connections between the access node, e.g., configured as a gNB, and UEs.

By means of the LL-DU, each higher-layer sub-node obtains full support of the radio protocol stack, such that complete base station functionality, such as a gNB, is obtained for each connected core network. In the context of 5G RAN, full support may refer to a user plane protocol stack of SDAP/PDCP/RLC/MAC/PHY and a control plane protocol stack of RRC/PDCP/RLC/MAC/PHY. A split between the respective higher-layer sub-node and the lower-layer sub-node may be configured between RLC and PHY. The split may specifically be configured between RLC and MAC, or between MAC and PHY. Moreover, as will be further described, the split between higher-layer and lower-layer sub-node may be different from legacy CU-DU split. The combined structure forms an access node arrangement where each higher-layer sub-node is configured to form an individual base station, making use of the common LL-DU, where each individual base station can be independently operated, e.g., by different operators. The higher-layer sub-nodes of the access node can be implemented in different data centers or clouds. Data sent/received over the air interface to and from UEs is controlled by a scheduler, that allocate physical layer resources for the downlink and the uplink, e.g., as provided in 3GPP Technical specification 38.300 clause 10.1, which can control the amount of radio resources used by each operator. The scheduler is thus configured to manage allocation of radio resources for the respective higher-layer sub-nodes, by extension for each network of the respective operator. In this context, the access network may be shared in at least some access nodes. The whole wireless network may on the other hand not be shared, hence mobility may be configured to be handled per operator. According to some examples, the wireless network of an operator which owns and/or controls the LL-DU is referred to as Master network, including a Master core network. The higher-layer sub-node of the Master network is herein referred to as the Master sub-node, wherein the combined LL-DU and Master sub-node forms a Master access node. The Master sub-node configures the LL-DU via an interface, and controls allocation of resources in the LL-DU dependent on originating CN. Other wireless networks which make use of the LL-DU in the access node arrangement by connection of its higher-layer sub-node are referred to as Slave networks. The higher-layer sub-node of the Slave network is herein referred to as the Slave sub-node.

FIG. 2A illustrates the RAN architecture according to various examples of the proposed solution, wherein various interfaces are shown. Four CNs are schematically shown, by way of example, which have separate higher-layer sub-nodes of an access node arrangement 20, where higher-layer sub-nodes 300 and 301 are identified. The higher-layer sub-nodes of the access node arrangement 20 are all connected to the same, i.e., one common, lower-layer sub-node, LL-DU, 200. In other words, different higher-layer sub-nodes of the access node arrangement 20 are used by different networks, whereas they all share use of the common lower-layer sub-node 200.

In this drawing, a Master network is indicated to the right, whereas Slave networks 1-3 are indicated to the left. In this context, the Master network configures, by the Master sub-node 300, Fx communication interfaces between the LL-DU 200 and transmit data buffers in the various higher-layer sub-nodes. The transmit data buffer is used to store the DL data in the higher-layer sub-node of the respective network until the scheduler has allocated resources to transmit the data to a UE. The scheduler is thus configured to manage allocation of downlink data from the respective data buffers in the higher-layer sub-nodes. Once resources are allocated, the scheduler indicates to the data buffer to send the buffered data to the LL-DU 200. In this context it may be noted that the Master sub-node 300 need not comprise a data buffer and may thus merely be configured to control one or more Slave networks. An Fy interface is configured between the Master sub-node 300 and the LL-DU 200 for providing control information, including configuration and control signaling, to the LL-DU 200. The Master sub-node 300 is further configured with Fz interfaces to each higher-layer sub-nodes of the Slave networks, such as Slave sub-node 301.

FIG. 2B corresponds to FIG. 2A, but with a slightly different presentation. Herein, it is more clearly indicated that the RAN protocol stack of the access node arrangement 20 may maintain the CU-DU split (F1) for each network, but that the DU comprises a further split to identify the (common) LL-DU 200. Each higher-layer sub-node 300, 301 thus comprises a CU and parts of legacy DU. For each network, the access node arrangement 20 may therefore identify three sub-nodes. For the example of Master network CN-M, the access node arrangement 20 may comprise a CU (CU_M) 300A, a DU (DU_M) 300B, and the LL-DU 200. For the example of Slave network CN-1, the access node arrangement 20 may comprise a CU (CU_1) 301A, a DU (DU_1) 301B, and the LL-DU 200.

From a User Plane perspective, a lower-layer split is defined between MAC and PHY, or between RLC and MAC as illustrated, where a scheduler 214 is placed in the LL-DU. It is then possible to connect the higher-layer sub-nodes 300, 301 of different networks in parallel to the same LL-DU 200, i.e., such that the higher-layer sub-nodes 300, 301 of different networks are simultaneously connected to the same LL-DU 200.

The scheduler 214 is in this example located in the LL-DU 200. Thus, management of resource allocation and scheduling of DL data is handled in the LL-DU 200. The LL-DU 200 is configured to control the DL Data buffers in the respective higher-layer sub-node 300, 301 to send data over the corresponding Fx interface to the LL-DU 200, based on allocation by the scheduler 214.

FIG. 2C illustrates an alternative example, where the scheduler 214 is comprised in the Master sub-node 300, such as in the Master DU (DU_M) 300B. Thus, management of resource allocation and scheduling of DL data is configured to take place in the Master sub-node 300. The Master sub-node 300 is configured to control the DL Data buffers in the respective higher-layer sub-node 300, 301 to send data over the corresponding Fx interface to the LL-DU 200, based on allocation by the scheduler 214.

As exemplified in FIGS. 2A, 2B and 2C, the scheduler 214 is thus configured to manage allocation of DL data from respective data buffers in the higher-layer sub-nodes 300, 301, as shown in these drawings. In other words, each higher-layer sub-node 300, 301 comprises a data buffer for holding DL data to be transmitted, and the scheduler 214 is configured to manage resource allocation for all higher-layer sub-nodes 300, 301 of the access node arrangement 20. This may include allocating resources dependent on the core network association of the data, i.e., dependent on the core network CN-1, CN-M connected to the higher-layer sub-node 300, 301 comprising the buffer holding data.

In both examples of FIGS. 2B and 2C, DL RAN data link for each network making use of the access node arrangement 20 thus ends in a buffer before the scheduler 214 decides which data from which higher-layer entity 300, 301 to receive in the common LL-DU 200, for subsequent transmission over a radio link, e.g., to a UE. In the UL (Uplink), data belonging to the different networks are distributed from the LL-DU 200 to the correct higher-layer sub-node 300, 301 based on what operator the data belongs to.

The proposed solution brings about that the scheduler 214 can manage resource allocation and scheduling based on what operator/network to prioritize. This may be based on agreements and usage of available radio resources, which can change over time. Resource management, including scheduling, may be based on the service associated with the data, latency requirements, amount of data, radio resources allowed per operator, etc.

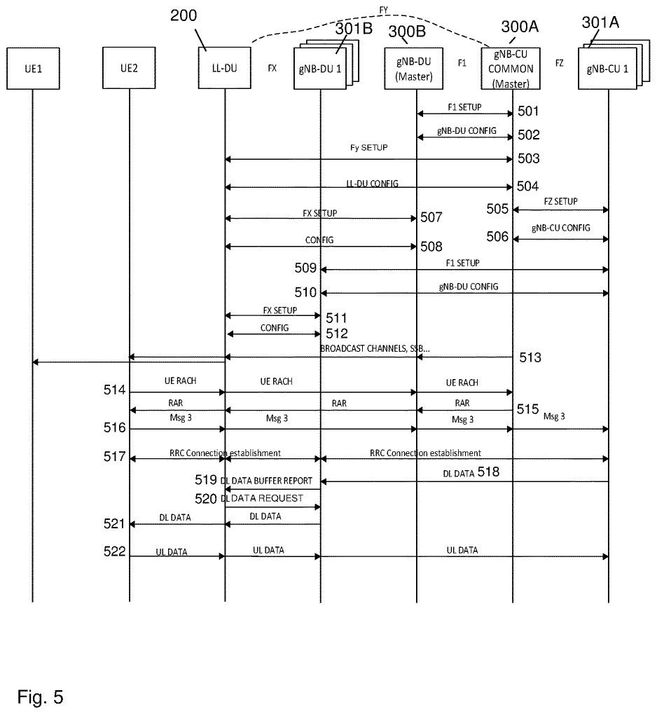

From a Control Plane perspective, broadcast signaling needs to be consistent and with one source. According to one aspect of the proposed solution, broadcast signaling is carried out under control of one network, e.g., the Master network, from its higher-layer sub-node 300. Also, when a UE accesses the network, such as when initiating network registration, a Master control layer 300C for controlling radio resources for any connected CN is hereby proposed to handle this before connecting the UE to the relevant CN of the network to which the UE belongs. This too involves control signaling. The Master sub-node 300 may thus be configured to control signaling, by the Master control layer 300C, such as broadcasting and random access signaling, including sending messages in a random access procedure (as explained with reference to FIG. 5) for a plurality of higher-layer sub-nodes, such as any higher-layer sub-node connected to the LL-DU 200.

By way of example, this Master control layer 300C will be referred to as a common control layer and is occasionally exemplified as Master RRC 300C herein. The Master RRC 330C may be configured to control random access signaling for any higher-layer sub-node connected to the lower-layer sub-node. This random access signaling may form part of UE registration. In this context, registration may comprise registration management procedures as described in 3GPP Technical specification 4.2.2. This too may be managed by the Master sub-node 300.

According to one example, broadcast signaling is sent from the Master control layer 300C, e.g. the RRC implemented in the Master sub-node 300, and down via its protocol stack to the LL-DU 200 to be sent out in SSBs (Synchronization Signal Blocks). The LL-DU 200 is controlled from the Master control layer 300C over the Fy interface. The Master control layer 300C is controlled by Operation and Management (O&M) of the Master network, i.e. for the operator which controls and owns the rights to use the spectrum for radio communication, while the other control layers (RRCs) the higher-layer sub-nodes of the respective Slave networks, such as control layer 301C in higher-layer sub-node 301, are partly controlled by the Master control layer 300C (primarily referred to as Master RRC 300C going forward). The control layer 300C, e.g., RRC, implemented by the Master sub-node may thus be configured to control broadcast signaling for any higher-layer sub-node of the access node arrangement 20.

In some examples the Master RRC 300C is implemented in the higher-layer sub-node of the operators with traffic, i.e., the Master RRC 300C is comprised in the higher-layer sub-node 300 of the Master network which also handles data traffic and comprises a data buffer. However, in an alternative example, the protocol stack of the Master network is configured for purposes of controlling the access node for other (Slave) networks only and need not have any UEs camping, meaning that the UE monitors the relevant System Information and the paging channel of the cell, e.g. as defined in 3GPP Technical specification 38.304, clause 5.2.5, on that channel. The Master sub-node 300 may in this example not be configured to buffer any data for transmission on a data channel such as PDSCH (Physical Downlink Shared Channel).

The Master RRC 300C functionality is configured to handle broadcast information and at least random access reception for non-registered UEs. In some examples, random access messages received from registered UEs will be forwarded to the respective RRC (e.g., 301C) in the higher-layer sub-node (e.g., 301) of the network to which the UE belongs over the configured Fz interface.

Once registered to one of the active operators connected to the access node arrangement 20, RRC signaling, mobility etc. is handled in a dedicated RRC in the higher-layer sub-node connected to the core network of the associated operator. By way of example, once a UE belonging to Slave network 1 is connected to that network through the access node arrangement 20, RRC signaling with that UE is handled by the RRC 301C of the higher-layer sub-node 301.

The Master RRC 300C thus handles the broadcast signaling and at least initial steps of initial access and connection (e.g., by a random access procedure) of UEs belonging to any network connected, through respective higher-layer sub-nodes 300, 301, to the access node arrangement 20. The Master RRC 330C may thus be configured to control random access signaling for any higher-layer sub-node connected to the LL-DU 200. The Master RRC and its associated/connected Master CN, defines the common configuration of the RAN HW, e.g., information related to supported QoS (Quality of Service) flows, therefore the common RRC 300C and Core Network may communicate the configurations and limitations of the LL-DU node to the dedicated higher-layer sub-nodes 301, e.g., over the configured Fz interface(s).

With reference to legacy 5G standards, the proposed solution may identify the addition of a new low-layer sub-node 200, LL-DU, which contains the Lower Layers (PHY and optionally MAC). The LL-DU 200 further comprises a radio unit which is configured to send physical channels for any connected network, the LL-DU 200 thus handles all transmissions and receptions over the air for the access node arrangement 20, for any connected core network. In some examples, the common scheduler 214 is comprised in the LL-DU 200

Regarding mobility, idle mode (also including RRC_Inactive) mobility is handled by the UEs identifying the cells where the UE can camp based on the PLMN used by the UE. For Connected mode it is beneficial that different operators handle mobility separately, since one operator may share some access nodes with other operators, and not others. Therefore, neighbor cells may be different for different operators. For the example of 5G, 3GPP refers to RRC_Connected (in RAN) and CM-Connected (in CN) to identify connected mode.

Based on the architecture described herein, and as shown by way of example in FIGS. 2A-2C, UEs just see one access node, with several PLMNs listed in the broadcast information (provided by the Master RRC 300C). The Master RRC 300C of the higher-layer sub-node 300 of the Master network may thus be configured to control the LL-DU 200 to broadcast information identifying network identity associated with any connected higher-layer sub-node 300, 301. From the UE's perspective, broadcasting may in this context appear as corresponding to Multi-Operator Radio Access Network (MORAN) broadcasting, a system concept where the same RAN is shared by two core networks of different operators having its own separate frequencies in the spectrum.

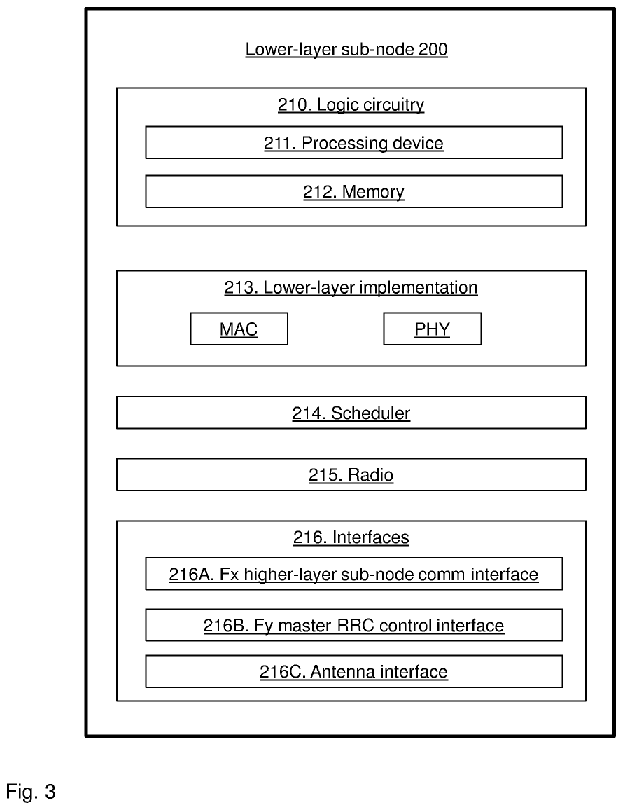

FIG. 3 schematically illustrates a lower-layer sub-node 200, also referred to as LL-DU 200 for short herein, representing a lower-layer entity according to various examples of the proposed solution, usable in common by a plurality of operators and networks in an access node of a RAN.

The LL-DU 200 comprises logic circuitry 210 configured to control operation. This may include communication of data and signals between one or more core networks and an air interface.

The logic circuitry 210 may include a processing device 211, including one or multiple processors, microprocessors, data processors, co-processors, and/or some other type of component that interprets and/or executes instructions and/or data. Processing device 211 may be implemented as hardware (e.g., a microprocessor, etc.) or a combination of hardware and software (e.g., a system-on-chip (SoC), an application-specific integrated circuit (ASIC), etc.). The processing device 211 may be configured to perform one or multiple operations based on an operating system and/or various applications or programs.

The logic circuitry 210 may further include memory storage 212, which may include one or multiple memories and/or one or multiple other types of storage mediums. For example, memory storage 312 may include a random access memory (RAM), a dynamic random access memory (DRAM), a cache, a read only memory (ROM), a programmable read only memory (PROM), flash memory, and/or some other type of memory. Memory storage 212 may include a hard disk (e.g., a magnetic disk, an optical disk, a magneto-optic disk, a solid state disk, etc.). The memory storage 212 is configured for holding computer program code, which may be executed by the processing device 211, wherein the logic 210 is configured to control the LL-DU 200 to carry out any of the steps as provided herein. Software defined by said computer program code may include an application or a program that provides a function and/or a process. The software may include device firmware, an operating system (OS), or a variety of applications that may execute in the logic circuitry 210.

The LL-DU 200 may implement lower layers 213 of the radio protocol stack, specifically PHY and optionally MAC, which are used to carry data and support higher layers of the radio protocol stack. This is handled by program code and instructions of the logic circuitry 210, and in communication with higher layers of the protocol stack supported in one or more separate higher-layer sub-nodes, specifically a higher-layer (Master) sub-node 300 of a Master network of the same access node arrangement 20, as described. The LL-DU 200 is thus configured to provide connectivity through each connected higher-layer sub-node to separate associated core networks CN-1, CN-M. In this context, each core network, e.g., CN-1, has connectivity to one associated higher-layer sub-node 301 of the access node arrangement 20, wherein that higher-layer sub-node 301 is connected to the LL-DU 200 to, in combination, implement the whole radio protocol stack.

The LL-DU 200 may in various examples further comprise a scheduler 214, configured to manage allocation of resources for data communication between the air interface and one or more connected networks. The allocation of resources to the different networks can be made based on agreements between the operators, QoS of the data, priority of the connection, the signal quality to the UEs etc. Specifically, the scheduler 214 may be configured with control information, by a Master or common RRC 300C of a connected higher-layer sub-node, to manage allocation of resources for data communication dependent on the associated connected core network involved in the data communication, as described.

The LL-DU 200 may further comprise a radio unit 215 comprising one or more radio transceiver(s) for wireless communicating with other sub-nodes of the radio communication network 100, such as the UE 10. The radio unit 215 may thus include a radio receiver and transmitter for communicating through at least an air interface. The LL-DU 200 may realize coverage for one cell of any connected wireless network. In other words, the LL-DU 200 may be configured with a cell identity shared by any connected higher-layer sub-node of the access node arrangement 20.

The LL-DU 200 further comprises various interface 216 for data and control signaling, as described.

An Fx interface 216A is configured to any connected higher-layer sub-node (and by extension the respective associated core network). The Fx interface is inter alia usable for receiving DL data from data buffers in connected higher-layer sub-nodes, under control of the scheduler 214. The Fx interface may further be used for sending UL data received from a UE over the air interface (Uu) to the associated higher-layer sub-node 300, 301 and for control signaling.

An Fy interface 216B is configured to a Master RRC 300C, for configuration and control of the LL-DU 200 by a controlling network, such as a Master network of the operator owning or administering the LL-DU 200. The interface Fy is thus a control interface, configured to connect to one higher layer sub-node configured as the Master sub-node, to receive configuration for controlling signaling for any connected higher-layer sub-node.

An interface 216C may be included for connection to an antenna for communication over the air.

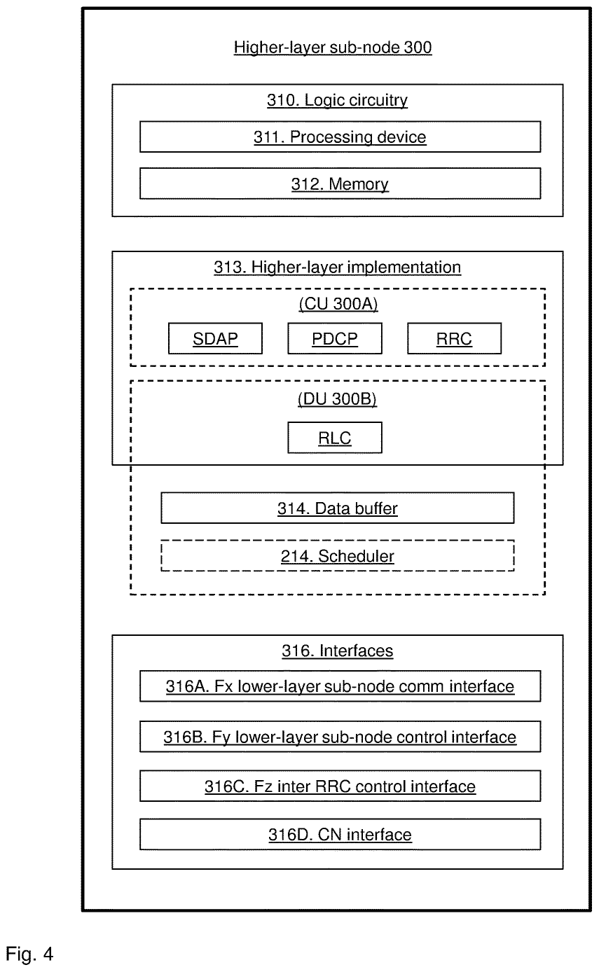

FIG. 4 schematically illustrates a higher-layer sub-node 300, representing a higher-layer entity according to various examples of the proposed solution, operated by one single operator and thus associated with one network (e.g., PLMN-Public Land Mobile Network). The higher-layer sub-node 300 is configured to be used with the LL-DU 200 to form an individual base station, e.g., a gNB, of a RAN for the associated network.

It may be noted that the higher-layer sub-node of FIG. 4 is indicated by numeral 300, which is primarily used for identifying the higher-layer sub-node of the Master network herein. However, unless where specifically noted below, the corresponding function and structure may be used in the higher-layer sub-node of any Slave network, e.g., higher-layer sub-node 301.

The higher-layer sub-node 300 may be configured solely in software code configured to be run by logic circuitry to implement layers of the radio stack for communicating with other entities such as an associated core network and the LL-DU 200. However, it will be described below as comprising the logic circuitry. In some examples, the higher-layer sub-node 300 may be co-located with one or more entities of the core network of the associated network, such as in a data center or in the cloud.

The higher-layer sub-node 300 may comprise logic circuitry 310 configured to control operation. This may include communication of data and signals between one or more core networks and an air interface.

The logic circuitry 310 may include a processing device 311, including one or multiple processors, microprocessors, data processors, co-processors, and/or some other type of component that interprets and/or executes instructions and/or data. Processing device 311 may be implemented as hardware (e.g., a microprocessor, etc.) or a combination of hardware and software (e.g., a system-on-chip (SoC), an application-specific integrated circuit (ASIC), etc.). The processing device 311 may be configured to perform one or multiple operations based on an operating system and/or various applications or programs.

The logic circuitry 310 may further include memory storage 312, which may include one or multiple memories and/or one or multiple other types of storage mediums. For example, memory storage 312 may include a random access memory (RAM), a dynamic random access memory (DRAM), a cache, a read only memory (ROM), a programmable read only memory (PROM), flash memory, and/or some other type of memory. Memory storage 312 may include a hard disk (e.g., a magnetic disk, an optical disk, a magneto-optic disk, a solid state disk, etc.). The memory storage 312 is configured for holding computer program code, which may be executed by the processing device 311, wherein the logic 310 is configured to control the higher-layer sub-node 300 to carry out any of the steps as provided herein. Software defined by said computer program code may include an application or a program that provides a function and/or a process. The software may include device firmware, an operating system (OS), or a variety of applications that may execute in the logic circuitry 310.

The higher-layer sub-node 300 may implement higher layers 313 of the radio protocol stack, specifically RLC, SDAP and PDCP, as well as RRC for the control plane. Where the higher-layer sub-node is a Master sub-node 300, the RRC may be configured as a Master, or common, RRC 300C as noted herein, to at least partly control further higher-layer sub-nodes 301 of Slave networks. Where the higher-layer sub-node is a Slave sub-node 301, the RRC may be configured as a dedicated RRC 301C for that network. The higher-layer implementation 313 is handled by program code and instructions of the logic circuitry 310 and operates in communication with lower layers of the protocol stack supported in the LL-DU 200.

In some examples, the higher-layer sub-node 300 further comprises a data buffer, for buffering DL data.

The higher-layer sub-node 300 may in various examples, as indicated in FIG. 2C, further comprise a scheduler 214, configured to manage allocation of resources for data communication between the higher-layer sub-node 300 and an air interface configured by the LL-DU 200. Specifically, the scheduler 214 may be configured with control information, by the Master RRC 300C, to manage allocation of resources for data communication dependent on the associated connected core network involved in the data communication, as described.

The higher-layer sub-node 300 is configured to operate in combination with the LL-DU 200 which implements complementary parts of the radio protocol stack, such that the combined higher-later sub-node and LL-DU 200 implement the full radio protocol stack where the implemented layers of the LL-DU 200 carry data of the implemented layers of the higher-layer sub-node, and wherein the LL-DU 200 further comprises a radio unit for communicating through at least an air interface.

The higher-layer sub-node 300 further comprises various interface 316 for data and control signaling, as described.

An Fx interface 316A is configured to connect to the LL-DU 200. The Fx interface is inter alia usable for receiving data from the LL-DU 200 in the UL, and for feeding data from the data buffer 314, where such data buffer is comprised in higher-the layer sub-node 300, under control of the scheduler 214 (comprised in the higher-layer sub-node 300 or in the LL-DU 200). The Fx interface may further be used for control signaling.

An Fy interface 316B is comprised in the higher-the layer sub-node operating as a Master sub-node 300. The Fy interface is configured to connect the RRC 300C of the Master sub-node 300 to the LL-DU 200 and is usable to configure the LL-DU 200. This may comprise transmitting, to the LL-DU 200, configuration which the scheduler 214, when comprised in the LL-DU 200, to manage resource allocation, including scheduling, for any higher-layer sub-node 300, 301 connected to the LL-DU 200. The Master sub-node 300 may thus be configured to control the scheduler 214 to manage allocation for the higher-layer sub-nodes 300, 301 connected to the LL-DU 200 in the access node arrangement 20. By means of the interface Fy, the LL-DU 200 may receive configuration for controlling signaling for any connected higher-layer sub-node. Based on the received configuration, the LL-DU 200, when comprising the scheduler 214, may be configured to control the scheduler 214 to manage allocation for any connected higher-layer sub-nodes. As exemplified herein, this control, by the Master sub-node 300, may comprise transmitting control information which controls resource allocation dependent on core network association of the respective connected higher-layer sub-node 300, 301. The scheduler may thus be configured, by the control information, to manage allocation based on the associated core network of the UE, i.e., based or dependent on originating core network for DL and based on terminating core network for UL. The control information may in this context be configured dependent on operator agreements, such as between the operator of the Master network and the operator of the Slave network(s), which sets extent and restrictions on e.g., bandwidth and latency. The control information may in this context configure the scheduler to allocate resources with priority based on which core network the data to be scheduled is associated with (where the data originates from or where it is destined). In other words, the scheduler may be configured to manage allocation with priority based on requesting core network.

An Fz interface 316C may further be comprised. The Fz interface is configured to connect the RRC of the higher-layer sub-node with an RRC of a further higher-layer sub-node. Where the higher-layer sub-node is a Master sub-node 300, the Fz interface may connect its Master RRC 300C to one or more RRCs 301C of respective Slave networks. Where the higher-layer sub-node is a Slave sub-node 301, the Fy interface may connect its RRC 301C to the Master RRC 300C of a Master sub-node 300. The interface Fy is thus used for configuration and control between higher-layer sub-nodes by a controlling network, such as a Master network of the operator owning or administering the Master sub-node 300.

An interface 316D is further included, configured for connection to a core network (CN), such as a single CN, which e.g., may be the core network CN-M of the Master network or CN-1 of Slave network 1. In other words, in the architecture of the access node arrangement 20, each higher-layer sub-node comprises an interface 316D configured to provide connectivity to a separate core network.

In some examples, as indicated by dashed lines in FIG. 4 and indicated in FIGS. 2B and 2C, the access node arrangement 20 may configured such that (here exemplified for the Master network) the higher-layer sub-node 300 comprises a CU 300A, (CU_M) and at least the RLC of a DU, (DU_M). In this context, the higher-layer sub-node 300 comprises the CU and a first part of the DU of the legacy CU-DU split. The higher-layer sub-node 300 is thus connectable to the LL-DU 200 which implements a second, lower layer, part in common for a plurality of DUs of different higher-layer sub-nodes 300, 301. In an example where this legacy CU-DU split is kept, as shown by example in FIG. 2B, the access node arrangement 20 thus comprises a plurality of CUs CU_1, CU_M, and a plurality of DUs DU_1, DU_M. The respective higher-layer sub-node 300, 301 separately implements one of said CUs 300A, 201A and a first DU part 300B, 301B of one of said DUs. The LL-DU 200 implements a second, lower layer, DU part 213 in common for the plurality of DUs. In this context, the first DU part 300B, 301B and the second, lower layer, DU part 213, provide combined implementation of the layers of one DU. For the example of Slave network 1, the access node arrangement 20 is configured with a CU (CU_1) 301A and a DU part (DU_1) 301B in the higher-layer sub-node 301, and a second, lower layer, DU part 213 implemented in the LL-DU 200. FIG. 5 shows a signaling diagram, where signals and configuration are schematically shown between the various sub-nodes of the proposed solution.

Two different UEs 1 and 2 are indicated, of which at least UE2 is initially not registered to its network.

The LL-DU (lower-layer sub-node) 200 is shown, which is being configured by the higher-layer sub-node 300 of the Master network to be connected to the Master network and at least one additional, Slave, network comprising a higher-layer sub-node 301. The higher-layer sub-nodes 300, 301 are here shown with two sub-parts 300A, 300B and 301A, 301B, respectively, similar to FIGS. 2B and 2C and as described with reference to FIG. 4.

The higher-layer sub-node 300 of the Master network includes a sub-part 301A, labelled gNB-CU (Master). This sub-part 301A supports and handles SDAP, PDCP and a Master RRC 300C, and is inter alia operated to configure higher-layer sub-nodes 301 of other connected networks, and the lower-layer sub-node 200. The higher-layer sub-node 300 of the Master network further includes a sub-part 300B, labelled gNB-DU (Master), comprising a sub-part of legacy DU functionality as described. This sub-part 300B implements and handles RLC for the Master network and may further comprise a buffer.

In a corresponding manner, the higher-layer sub-node 301 of the Slave network which does not own or control the lower-layer sub-node 200 includes a sub-part 301A, labelled gNB-CU1, comprising CU functionality. This sub-part 301A implements and handles SDAP, PDCP and a network-specific RRC 301C of the Slave network. The higher-layer sub-node 301 of the Slave network further includes a sub-part 301B, labelled gNB-DU1, comprising a sub-part of legacy DU functionality as described. This sub-part 301B implements and handles RLC for the Slave network and comprises a data buffer. Interfaces F1, Fx, Fy and Fz are indicated at the top of the drawing between the cooperating entities in accordance with the preceding description.

Various aspects and examples of the proposed solution are indicated in the drawing, according to the following:
501 indicates setup of the F1 interface in the Master sub-node 300 between the Master CU part (CU_M) 300A and the Master DU sub-part (DU_M) 300B.
At 502 a configuration step is carried out between sub-part 300A (CU_M) and sub-part 300B (DU_M), using the F1 interface.
503 indicates setup of the Fy interface between the Master sub-node 300, specifically its CU part 300A, and the LL-DU 200.
At 504 a configuration step of radio configurations is carried out between sub-part 300A and the LL-DU 200 using the FY interface.
505 indicates setup of the Fz interface between the Master sub-node 300 and the Slave higher-layer sub-node 301. Specifically, the interface Fz is set up between the Master RRC 300C of the Master CU part 300A and the RRC 301C the Slave CU part 301A.
At 506 a configuration step of the cell is carried out between the Master CU 300A and the (each) Slave CU 301A, using the FZ interface.
507 indicates setup of the Fx interface between the Master sub-node 300, specifically its DU part 300B, and the LL-DU 200.
508 indicates configuration of the FX is further indicated, carried out by the Master sub-node 300, exemplified here by the Master DU 300B
509 indicates setup of the F1 interface in the Slave sub-node 301 between the Slave CU part (CU_1) 301A and the Slave DU sub-part (DU_1) 301B. This corresponds to step 501.
At 510 a configuration step is carried out between sub-part 301A (CU_1) and sub-part 301B (DU_1), using the F1 interface, corresponding to step 502.
511 indicates setup of the Fx interface between the Slave sub-node 301, specifically its DU part 301B, and the LL-DU 200. This corresponds to step 507.
512 indicates configuration of the FX is further indicated, carried out by the Slave sub-node 301, exemplified here by the Slave DU 301B. This corresponds to step 508.
513 indicates that broadcast channels are transmitted from the Master sub-node 300, from Master CU 300A through Master DU 300B, to the LL-DU 200 for transmission by radio on a physical channel. Information related to the Slave network, such as PLMN identification, to be included in broadcast signaling may be obtained in the Master CU 300A from the Slave CU 301A in step 506. The access node arrangement 20, comprising the LL-DU 200 and the higher-layer entities 300 and 301, provide individual base station (e.g., gNB) functionality for both the Master network and the Slave network. Broadcast signals and SSB may be received by UEs in the area, such as UE1 and UE2.
514 indicates a first step in a random access process (RACH) for connecting UE2 to its associated network, which uses the access node arrangement 20 as a Slave network. The RACH process is also referred to as Initial Access, and involves a sequence of process between UE2 and the access node arrangement 20 in order for UE to acquire uplink synchronization and obtain specified ID for the radio access communication. The random access process comprises a random access transmission (e.g. Msg.1) from UE2, which message is received in the LL-DU 200. The random access transmission may be referred to as a preamble, which may constitute a random access request, such as a random access channel (RACH) request. In one example, the Master sub-node 300 is configured to handle initial steps of RACH also for UEs belonging to Slave networks, as will be described below. In such an example, the random access message is transported to the Master CU 300A from the LL-DU 200.
515 indicates that the Master CU 300A responds through the LL-DU 200 with a random access response message.
516 indicates transmission of Msg.3, comprising an ID of the UE2, by the UE2, which is received in the LL-DU 200 and transported through to the Master CU 300A. The Master CU 300A forwards or reports the message to the Slave CU 301A of the network associated with the UE2, based on network information included in or determined based on Msg.3. This may conclude the involvement of the Master sub-node 300 in the RACH process. In other words, the Master RRC 300C in the Master CU may be configured to forward a message received from the UE2 subsequent to reception of the random access request. Based on the subsequent message (e.g., Msg. 3) indicating network association, received from the UE, forwarding is made to the RRC (301C) of the higher-layer entity which corresponds to said network association. The RRC 301C of the slave sub-node, i.e., Slave CU 301A, is thus configured to receive a message (e.g., Msg. 3) over the RRC interface Fz from the Master sub-node 300A, which message originates from the UE 2 following a random access request, e.g., Msg. 1.
517 connection establishment of the UE2 carried out over the LL-DU 200 to the correct network, i.e., via the Slave DU 301B to the Slave CU 301A. The Slave CU 301A is further connected to the related Slave core network CN-1 (not shown here).
518 indicates DL transmission of data from the Slave core network CN-1. The data is transmitted with protocol layer support from Slave CU 301A to the buffer 314 in Slave sub-node 301B. From there, the data is scheduled and conveyed by LL-DU 200 to the UE2. As noted, the scheduler 214 may be comprised in the LL-DU 200 or in the Master DU 300B. The remaining steps of FIG. 5 relate to the example of the scheduler 214 being comprised in the LL-DU 200. The alternative example of the scheduler 214 being comprised in the Master DU 300B will additionally be described briefly.
519 indicates that the Slave sub-node 301B transmits a DL buffer status report (BSR) to the scheduler 214 comprised in the LL-DU 200, which BSR is indicative of the data received at 518. For the alternative example of the scheduler 214 being comprised in the Master DU 300B, the BSR is transmitted to the Master DU 300B.
   Resource allocation and scheduling may be carried out by the scheduler 214 based on control information obtained in or from the Master sub-node 300. Where the scheduler 214 is comprised in the LL-DU, the control information may be obtained using the Fy interface. Obtaining the control information in the LL-DU 200 may take place at step 504, or later corresponding to step 504, such as after the Fz setup and configuration of steps 505 and 506 have been established. The control information may determine e.g., an indication of allowed bandwidth or latency, and/or priority to obtain resource allocation in relation to other networks using the access node arrangement 20.
520 indicates that the scheduler (in the LL-DU 200) sends a DL data request to the Slave sub-node 301B, which is indicative of the scheduling determined by the scheduler 214. This DL data request informs the Slave sub-node 301B how much data, and when, to send to the LL-DU 200 for data transmission using the radio unit 215.
At 521 data from the buffer in the Slave DU 301B is transmitted to the UE2 by the LL-DU 200, in accordance with the resource allocation determined by scheduler 214, based on the DL data request of 520.
522 indicates UL transmission of data from the UE2 in connected mode, wherein the data is received in the LL-DU 200 and conveyed to the associated higher-layer sub-node 301 for further transport to its core network CN-1.

In accordance with what is described herein, the scheduler 214 may be configured Master sub-node 300 to manage allocation with priority based on requesting core network. This way, the Master network, owning or administering the spectrum in the may maintain control over data traffic. Moreover, this allows for the operator of the network to make technical configuration of the scheduling based on different agreements with operators of the Slave networks, such as by controlling the scheduler manage resource allocation for different high-layer sub-nodes 3001 based on different requirements on e.g., latency and/or bandwidth.

According to one aspect of the proposed solution, which has been described and exemplified in the foregoing, a common RAN node architecture is provided for an node arrangement 20 with split layer functionality, wherein said access node arrangement comprises:
at least two higher-layer sub-nodes 300, 301, wherein each higher-layer sub-node is configured to implement higher layers 313 of a radio protocol stack for individual core network connectivity;
a lower-layer sub-node 200, shared by the higher-layer sub-nodes 300, 301, comprising a radio unit 215 and being configured to implement lower layers 213 supporting the higher layers of the at least two higher-layer sub-nodes 300, 301 and to communicate lower layer data using the radio unit 215;
wherein the higher-layer sub-nodes have respective communication interfaces Fx for parallel connection to said lower-layer sub-node, whereby each higher-layer sub-node 300, 301 obtains full support of the radio protocol stack. In this context, parallel connection means that each higher-layer sub-node 300, 301 is individually and independently connected to the lower-layer sub-node 200 for data communication to/from the individual core network connected to the respective higher-layer sub-node 300, 301. The higher-layer sub-nodes are thus associated with separate core networks, but share the lower-layer sub-node 200.

Each higher-layer sub-node 300, 301 will thus form an individual base station, such as a gNB, when connected to an operated with the lower-layer sub-node 200, wherein each base station can be individually operated, e.g., by different operators. In this context, the access node arrangement comprises a single lower-layer sub-node 200 connectable to a plurality of higher-layer sub-nodes 300, 301.

The proposed solution further provides the benefit that the actual HW required at the air interface, as well as the spectrum, can be conveniently shared, while functions of the base station that can be configured by logic circuitry operating on software can be configured elsewhere and separately for each operator, such as in connection with the associated core network. This provides a way of re-using HW, which saves at least required material and energy.

According to another aspect, the proposed solution provides for a lower-layer sub-node 200 of an access node arrangement 20 having split-layer functionality for operation in a RAN, wherein said lower-layer sub-node 200 comprises:
a radio unit 215;
a communication interface Fx configured to provide parallel connection to a plurality of higher-layer sub-nodes 300, 301 of the access node arrangement, which higher-layer sub-nodes are each configured to implement higher layers of a radio protocol stack for individual core network connectivity; and
logic circuitry 210 configured to implement lower layers 213 of the radio protocol stack supporting the higher layers of the at least two higher-layer sub-nodes 300, 301 and to communicate lower layer data using the radio unit 215.

The lower-layer sub-node 200 thus forms a base station sub-unit for a complete base station, such as a gNB, configured by connecting the lower-layer sub-node 200 to a higher-layer sub-node. Specifically, a plurality of individual base station can be configured which share the common lower-layer sub-node 200, wherein each base station can be individually operated, e.g., by different operators. The proposed solution further provides the benefit that the actual HW required at the air interface can be conveniently shared, while functions of the base station that can be configured by logic circuitry operating on software can be configured elsewhere and separately for each operator, such as in connection with the associated core network. This provides a way of re-using HW, which saves at least required material and energy. In addition, a Master operator (i.e., an operator of a Master network), owning or administering the right to the radio spectrum and controlling the lower-layer sub-node 200, may allow other operators to connect to the lower-layer sub-node and obtain scheduling and resource allocation under control of or by agreement with the Master operator.

According to another aspect, the proposed solution provides for a higher-layer sub-node 300 (or 301) of use in an access node arrangement 20 having split-layer functionality for operation in a radio access network, wherein said higher-layer sub-node comprises:
an interface 316D configured to provide connectivity with one core network CN-1, CN-M;
logic circuitry 310 configured to implement higher layers 313 of a radio protocol stack; and
a communication interface Fx configured for connection to a lower-layer sub-node 200 configured to implement lower layers 213 supporting the higher layers of a plurality of higher-layer sub-nodes in parallel, said lower-layer sub-node comprising a radio unit 215 configured to communicate lower layer data,
wherein the higher-layer sub-node obtains full support of the radio protocol stack using said communication interface.

The higher-layer sub-node 300, 301 thus forms a base station sub-unit of a complete base station, such as a gNB, configured by connecting to the lower-layer sub-node 200. The proposed solution provides a split that defines an interface Fx to the lower-layer unit which comprises the required HW for radio communication at the air interface, which can be conveniently shared with other higher-layer sub-nodes. On the other hand, functions of the base station that can be configured by logic circuitry operating on software can be configured elsewhere, and separately for each operator. This provides greater flexibility for the operator in terms of computing infrastructure, by e.g., providing the capability of configuring the higher-layer sub-node in connection with the associated core network. In addition, an operator not owning its own spectrum may connect to a lower-layer sub-node 200 of a Master network and obtain scheduling and resource allocation under control of or by agreement with the operator of the Master operator which owns or administers the spectrum.

According to another aspect, the proposed solution provides for an access node arrangement 20 with split layer functionality for operation in a radio access network, wherein said access node arrangement comprising:
at least two higher-layer sub-nodes 300, 301, wherein each higher-layer sub-node is configured to implement higher layers 313 of a radio protocol stack for individual core network connectivity 316D;
a lower-layer sub-node 200, shared by the higher-layer sub-nodes 300, 301, comprising a radio unit 215 and being configured to implement lower layers 213 supporting the higher layers of the at least two higher-layer sub-nodes 300, 301 and to communicate lower layer data using the radio unit 215; and
a scheduler 214;
wherein one of said higher-layer sub-nodes is a Master sub-node configured to control the scheduler for managing allocation of resources for data communication for any of said higher-layer sub-nodes connected to the lower-layer sub-node.

The proposed access node arrangement 20 thus provides an architecture wherein the higher-layer sub-nodes 300, 301 each form a base station sub-unit of a complete base station, such as a gNB, configured by connecting to the lower-layer sub-node 200, and where the Master network controls resource allocation and scheduling for all base stations of the access node arrangement 20. This provides the additional benefit that resource allocation and scheduling for data traffic may be configured differently dependent on originating (or terminating) network. This allows for operators not owning its own spectrum right to conveniently may connect its higher-layer sub-node 301 to the lower-layer sub-node 200 of the Master network and obtain a reasonable level of resource allocation based on agreement with the operator of the Master operator which owns or administers the spectrum. Meanwhile, the proposed solution allows for the Master operator to maintain control, both in terms of scheduling and by controlling and carrying out broadcast signaling.

Various aspects of the proposed solution have been outlined in the foregoing. Any details and examples as provided herein may be combined in any way or form, or in accordance with any combination of the features of the items set out below.
Item 1. An access node arrangement with split layer functionality for operation in a radio access network, said access node arrangement comprising:
at least two higher-layer sub-nodes (300, 301), wherein each higher-layer sub-node is configured to implement higher layers (313) of a radio protocol stack for individual core network connectivity (316D);
a lower-layer sub-node (200), shared by the higher-layer sub-nodes (300, 301), comprising a radio unit (215) and being configured to implement lower layers (213) supporting the higher layers of the at least two higher-layer sub-nodes (300, 301) and to communicate lower layer data using the radio unit (215); and
a scheduler (214);
wherein one of said higher-layer sub-nodes is a master sub-node configured to control the scheduler for managing allocation of resources for data communication for any of said higher-layer sub-nodes connected to the lower-layer sub-node.
Item 2. The access node arrangement of item 1, wherein said master sub-node implements a Radio Resource Control layer, RRC (300C), and comprises an RRC interface (Fz) to RRC layer (301C) of any higher-layer sub-node connected to the lower-layer sub-node.
Item 3. The access node arrangement of item 2, wherein said RRC (330C) of the master sub-node is configured to control broadcast signaling for any higher-layer sub-node connected to the lower-layer sub-node.
Item 4. The access node arrangement of item 2 or 3, wherein said RRC (330C) of the master sub-node is configured to control the lower-layer sub-node to broadcast information identifying network identity associated with any connected higher-layer sub-node.
Item 5. The access node arrangement of any of items 2-4, wherein the RRC of the master sub-node is configured to control random access signaling for any higher-layer sub-node connected to the lower-layer sub-node.
Item 6. The access node arrangement of item, wherein the RRC of the master sub-node is configured to:
respond to a random access request from a User Equipment, UE, and
forward a subsequent message which indicates network association, received from the UE, to the RRC (301C) of the higher-layer entity which corresponds to said network association.
Item 7. The access node arrangement of any preceding item, wherein the scheduler is comprised in the lower-layer sub-node.
Item 8. The access node arrangement of item 7, wherein the lower-layer sub-node comprises a control interface (Fy) connected to the master sub-node, to receive configuration and to receive control signaling for the scheduler.
Item 9. The access node arrangement of any of items 1-6, wherein the scheduler is comprised in the master sub-node.
Item 10. The access node arrangement of any preceding item, wherein the scheduler is configured to manage allocation dependent on originating core network.
Item 11. The access node arrangement of any preceding item, wherein the scheduler is configured to manage allocation with priority based on requesting core network.
Item 12. The access node arrangement of any preceding item, wherein the scheduler is configured to manage allocation of downlink data transmission from respective data buffers in the higher-layer sub-nodes.
Item 13. The access node arrangement of any preceding item, wherein said lower-layer sub-node is configured with a cell identity shared by said higher-layer sub-nodes.
Item 14. The access node arrangement of any preceding item, wherein each higher-layer sub-node comprises a Radio Link Control, RLC, layer of the radio protocol stack.
Item 15. The access node arrangement of item 14, wherein a split between the respective higher-layer sub-node and the lower-layer sub-node is configured between the RLC and a physical layer, PHY, of the radio protocol stack.
Item 16. The access node arrangement of item 14, wherein a split between the respective higher-layer sub-node and the lower-layer sub-node is configured between the RLC, and a Medium Access Control layer, MAC, of the radio protocol stack.
Item 17. The access node arrangement of any of items 14-16, wherein each higher-layer sub-node comprises a central unit, CU, and at least the RLC of a distributed unit, DU, of the access node arrangement.
Item 18. The access node arrangement of any preceding item, comprising a plurality of central units, CU, (CU_1, CU_M) and a plurality of distributed units, DU, (DU_1, DU_M),
wherein the respective higher-layer sub-node (300) separately implements:
   one of said CUs (300A), and
   a first DU layer part (300B) of one of said DUs; and
wherein the lower layer sub-node (200) implements a second, lower DU layer part (213) in common for the plurality of DUs.
Item 19. The access node arrangement of any preceding item, wherein the higher-layer sub-nodes have respective communication interfaces (Fx) for parallel connection to said common lower-layer sub-node, whereby each higher-layer sub-node (300, 301) obtains full support of the radio protocol stack.
Item 20. The access node arrangement of any preceding item, wherein each higher-layer sub-node comprises an interface (316D) configured to provide connectivity to a separate core network (CN-1, CN-M).
Item 21. The access node arrangement of any preceding item, wherein said lower-layer sub-node comprises an antenna interface (216C).]
Item 22. A higher-layer sub-node (300) configured as a master sub-node in an access node arrangement (20) having split-layer functionality for operation in a radio access network, said higher-layer sub-node comprising:
an interface (316D) configured to provide connectivity with one core network (CN-M);
logic circuitry (310) configured to implement higher layers (313) of a radio protocol stack; and
a communication interface (Fx) configured for connection to a lower-layer sub-node (200), configured to implement lower layers (213) supporting the higher layers of each of a plurality of higher-layer sub-nodes in parallel, to obtain full support of the radio protocol;
wherein the logic circuitry is configured to a control a scheduler to manage resource allocation for any higher-layer sub-node connected to the lower-layer sub-node.
Item 23. The higher-layer sub-node of item 22, further comprising:
a data buffer, configured to provide data over said communication interface (Fx) to the lower-layer sub-node.
Item 24. The higher-layer sub-node of item 22 or 23, wherein the logic circuitry is configured to implement a Radio Link Control, RLC, layer of the radio protocol stack.
Item 25. The higher-layer sub-node of any of items 22-24, wherein the logic circuitry implements a Radio Resource Control layer, RRC (300C), and an RRC interface (Fz) connected to RRC layer (301C) of any higher-layer sub-node connected to the lower-layer sub-node.
Item 26. The higher-layer sub-node of item 25, wherein the RRC of the master sub-node is configured to control broadcast signaling for any higher-layer sub-node connected to the lower-layer sub-node
Item 27. The higher-layer sub-node of item 25 or 26, wherein the RRC of the master sub-node is configured to control the lower-layer sub-node to broadcast information identifying network identity associated with any connected higher-layer sub-node.
Item 28. The higher-layer sub-node of any of items 25-27, wherein the RRC of the master sub-node is configured to control random access signaling for any higher-layer sub-node connected to the lower-layer sub-node.
Item 29. The higher-layer sub-node of item 28, wherein the RRC of the master sub-node is configured to:
respond to a random access request from a User Equipment, UE, and
forward a subsequent message which indicates network association, received from the UE, to the RRC of the higher-layer entity which corresponds to said network association.
Item 30. The higher-layer sub-node of any of items 22-29, further comprising a control interface (Fy) to the scheduler, wherein the scheduler is comprised in the lower-layer sub-node.
Item 31. The higher-layer sub-node of any of items 22-29, further comprising said scheduler.
Item 32. A higher-layer sub-node (300) for use in an access node arrangement (20) having split-layer functionality for operation in a radio access network, said higher-layer sub-node comprising:
an interface (316D) configured to provide connectivity with one core network (CN-1);
logic circuitry (310) configured to implement higher layers (313) of a radio protocol stack; and
a communication interface (Fx) configured for connection to a lower-layer sub-node (200) configured to implement lower layers (213) supporting the higher layers of a plurality of higher-layer sub-nodes in parallel, wherein the higher-layer sub-node obtains full support of the radio protocol stack using said communication interface; and
an interface to a scheduler under control of a further higher-layer sub-node operating as master sub-node for resource allocation by the scheduler for said higher-layer sub-node, wherein the higher-layer sub-node is configured as a slave sub-node to the master sub-node.
Item 33. The higher-layer sub-node of item 32, wherein the logic circuitry implements a Radio Resource Control layer, RRC (301C), wherein the slave sub-node further comprises:
an RRC interface (Fz) to RRC layer (300C) of the master sub-node.
Item 34. The higher-layer sub-node of item 33, wherein the RRC of the slave sub-node is configured to receive a message over the RRC interface (Fz) from the master sub-node, which message originates from a User Equipment following a random access request.

1. An access node arrangement with split layer functionality for operation in a radio access network, said access node arrangement comprising:
at least two higher-layer sub-nodes, wherein each higher-layer sub-node is configured to implement higher layers of a radio protocol stack for individual core network connectivity;
a lower-layer sub-node, shared by the higher-layer sub-nodes, comprising a radio unit and being configured to implement lower layers supporting the higher layers of the at least two higher-layer sub-nodes and to communicate lower layer data using the radio unit; and
a scheduler;
wherein one of said higher-layer sub-nodes is a master sub-node configured to control the scheduler for managing allocation of resources for data communication for any of said higher-layer sub-nodes connected to the lower-layer sub-node.

2. The access node arrangement of claim 1, wherein said master sub-node implements a Radio Resource Control layer (RRC) and comprises an RRC interface to RRC layer of any higher-layer sub-node connected to the lower-layer sub-node.

3. The access node arrangement of claim 2, wherein said RRC of the master sub-node is configured to control broadcast signaling for any higher-layer sub-node connected to the lower-layer sub-node.

4. The access node arrangement of claim 2, wherein said RRC of the master sub-node is configured to control the lower-layer sub-node to broadcast information identifying network identity associated with any connected higher-layer sub-node.

5. The access node arrangement of claim 2, wherein the RRC of the master sub-node is configured to control random access signaling for any higher-layer sub-node connected to the lower-layer sub-node.

6. The access node arrangement of claim 1, wherein the RRC of the master sub-node is configured to:
respond to a random access request from a User Equipment (UE), and
forward a subsequent message which indicates network association, received from the UE, to the RRC of the higher-layer entity which corresponds to said network association.

7. The access node arrangement of claim 1, wherein the scheduler is comprised in the lower-layer sub-node.

8. The access node arrangement of claim 7, wherein the lower-layer sub-node comprises a control interface connected to the master sub-node, to receive configuration and to receive control signaling for the scheduler.

9. The access node arrangement of claim 1, wherein the scheduler is comprised in the master sub-node.

10. The access node arrangement of claim 1, wherein the scheduler is configured to manage allocation dependent on originating core network.

11. The access node arrangement of claim 1, wherein the scheduler is configured to manage allocation with priority based on requesting core network.

12. The access node arrangement of claim 1, wherein the scheduler is configured to manage allocation of downlink data transmission from respective data buffers in the higher-layer sub-nodes.

13. The access node arrangement of claim 1, wherein said lower-layer sub-node is configured with a cell identity shared by said higher-layer sub-nodes.

14. A higher-layer sub-node configured as a master sub-node in an access node arrangement having split-layer functionality for operation in a radio access network, said higher-layer sub-node comprising:
an interface configured to provide connectivity with one core network;
logic circuitry configured to implement higher layers of a radio protocol stack; and
a communication interface configured for connection to a lower-layer sub-node, configured to implement lower layers supporting the higher layers of each of a plurality of higher-layer sub-nodes in parallel, to obtain full support of the radio protocol;
wherein the logic circuitry is configured to a control a scheduler to manage resource allocation for any higher-layer sub-node connected to the lower-layer subnode.

15. The higher-layer sub-node of claim 14, further comprising:
a data buffer, configured to provide data over said communication interface to the lower-layer sub-node.

16. The higher-layer sub-node of claim 14, wherein the logic circuitry implements a Radio Resource Control layer (RRC) and an RRC interface connected to RRC layer of any higher-layer sub-node connected to the lower-layer sub-node.

17. The higher-layer sub-node of claim 16, wherein the RRC of the master sub-node is configured to control broadcast signaling for any higher-layer sub-node connected to the lower-layer sub-node.

18. The higher-layer sub-node of claim 16, wherein the RRC of the master sub-node is configured to control the lower-layer sub-node to broadcast information identifying network identity associated with any connected higher-layer sub-node.

19. The higher-layer sub-node of claim 16, wherein the RRC of the master sub-node is configured to control random access signaling for any higher-layer sub-node connected to the lower-layer sub-node.

20. The higher-layer sub-node of claim 19, wherein the RRC of the master sub-node is configured to:
respond to a random access request from a User Equipment (UE), and
forward a subsequent message which indicates network association, received from the UE, to the RRC of the higher-layer entity which corresponds to said network association.

21-23. (canceled)
